(19) United States
(12) Patent Application Publication
(10) Pub. No.: US 2015/0117622 A1
(43) Pub. Date: Apr. 30, 2015

(54) MULTI-SERVICE ANALOG TELEPHONE ADAPTER

(71) Applicants: Jan Fandrianto, Los Gatos, CA (US); Sam Sin, San Jose, CA (US); Kai Xiao, San Jose, CA (US)

(72) Inventors: Jan Fandrianto, Los Gatos, CA (US); Sam Sin, San Jose, CA (US); Kai Xiao, San Jose, CA (US)

(21) Appl. No.: 14/066,588

(22) Filed: Oct. 29, 2013

(51) Int. Cl. H04M 7/00; H04M 1/253

(52) U.S. Cl. CPC H04M 7/0066; H04M 1/2535
USPC 379/93.05

(57) ABSTRACT

A computer implemented method and system for bridging an analog telephone service to multiple network and telephony services (NTSs) provides a multi-service analog telephone adapter (MSATA) with software components and physical communication ports (PCPs). The PCPs establish a communication link to simultaneously access the NTSs implementing communications protocols, and receive user inputs from user devices in a voice mode or a data mode. The software components include a control engine for selectively routing and bridging a call to one or more NTSs based on the user inputs and predetermined criteria, a voice communication engine for accessing a voice communication service, a notification engine for generating and transmitting notifications, and a device management client engine, in communication with a device management server (DMS), for providing remote access to the MSATA for configuring parameters associated with the MSATA and the user devices. The DMS enables remote management and monitoring of the MSATA.

### CROSS REFERENCE TO RELATED APPLICATIONS

This application claims the benefit of provisional patent application No. 61/722,586 titled “A Multi-Service ATA Device with Cloud Management”, filed in the United States Patent and Trademark Office on Nov. 5, 2012.

The specification of the above referenced patent application is incorporated herein by reference in its entirety.

### BACKGROUND

An analog telephone adapter is a device that bridges an analog telephone or a plain old telephone service (POTS) phone to an internet protocol (IP) network, for example, a local area network, a wide area network, the internet, etc. The analog telephone adapter replaces a conventional home phone service with a network and telephony service, for example, a voice over IP (VoIP) service, also referred to as an IP telephony (IPT) service that supports multiple features. A user of the analog telephone adapter picks up the POTS phone to make and receive calls using the network and telephony service. The network and telephony service uses a signaling protocol, for example, a session initiation protocol (SIP) or a media gateway control protocol (MGCP) for delivering voice communications and multimedia sessions over the IP network. The analog telephone adapters, currently available, support either the SIP service or the MGCP service. Many off-the-shelf system on a chip (SoC) solutions comprise a central processing unit and Ethernet media access control (MAC)/physical layer (PHY) of the open systems interconnection (OSI) network model and some other peripherals on a single chip.

Some network and telephony services, for example, Google Talk™ use an extensible messaging and presence protocol (XMPP). The XMPP is an open communications protocol based on extensible markup language (XML) and combines voice, text messaging, and presence information in one network and telephony service. The conventional analog telephone adapters available in the market do not support the XMPP protocol. Therefore, the user has to use a software application on a personal computer or a smart phone to make a call to the user's contact on the XMPP service. An external intermediate glue logic server is required as a bridge to call the user's contact on the XMPP service. This approach of using the external intermediate glue logic server affects the call quality, is unreliable, is convoluted to set up, and is not as convenient as using the conventional home phone service to make calls.

In existing analog telephone adapters, each phone port is hard wired to one network and telephony service for all calls. The user cannot choose a preferred network and telephony service, for example, a VoIP service A for international numbers, a VoIP service B for domestic numbers, a VoIP service C for emergency numbers such as 911, etc. Hence, the user cannot take advantage of the call rates and features offered by different network and telephony service providers. The conventional analog telephone adapters lack integrated hardware components to access cellular services or public switched telephone network (PSTN) services for backup or to make emergency calls. The conventional analog telephone adapters do not support intelligent call routing to choose a particular network and telephony service based on a dialed number. The existing analog telephone adapters also do not support alphanumeric dialing, for example, dialing an alphanumeric user identifier. Moreover, these analog telephone adapters do not support voice dialing, for example, dialing a number when a user says a name of a contact from a contact list or a phone book. Furthermore, the existing analog telephone adapters do not support text message notifications.

The existing analog telephone adapters cannot access cloud networking services to manage and monitor the analog telephone adapters remotely from any location. These analog telephone adapters rely on a built-in web server and/or a command line utility for local device configuration and monitoring. The local device configuration and monitoring built-in utilities support a limited functionality and are constrained by memory size and processing speed of the central processing unit (CPU). Also, the local device configuration and monitoring built-in utilities cannot be accessed remotely, for example, over the internet, if the analog telephone adapter is behind a firewall.

Hence, there is a long felt but unresolved need for a multi-service analog telephone adapter that simultaneously accesses multiple network and telephony services implementing multiple communication protocols, intelligently routes calls based on numbers dialed, integrates hardware components for accessing cellular services and PSTN services, supports voice dialing and text message notifications, and supports cloud networking technologies for remotely managing and monitoring the multi-service analog telephone adapters. Moreover, there is a need for a computer implemented method and a computer implemented system that bridging an analog telephone service to one or more network and telephony services via the multi-service analog telephone adapter.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and the computer implemented system disclosed herein address the above stated needs for a multi-service analog telephone adapter that simultaneously accesses multiple network and telephony services implementing multiple communication protocols, supports intelligent call routing to select network and telephony services based on dialed numbers, integrates hardware components for accessing cellular services and public switched telephone network (PSTN) services, supports voice dialing and text message notifications, and supports cloud networking technologies for remotely managing and monitoring the multi-service analog telephone adapters. Moreover, the computer implemented method and the computer implemented system disclosed herein bridge an analog telephone service to multiple network and telephony services via the multi-service analog telephone adapter. As used herein, the term “network and telephony services” refers to communication services such as voice and data services associated with data storage, voice and data transmission, voice and data reception, data manipulation, data presentation, etc., implemented using a client-server or a peer-to-peer architecture based on communications protocols. Also, as used herein, the term “communications protocol”, also referred to as a “network protocol”, is a system of digital rules for exchanging messages within or between devices. The network and telephony services comprise, for example, a cellular service, a PSTN service, a voice over internet protocol (VoIP) service, a plain old telephone service (POTS), etc.

The computer implemented method and system for bridging the analog telephone service to one or more of multiple network and telephony services provides the multi-service analog telephone adapter. The multi-service analog telephone adapter comprises at least one processor and a non-transitory computer readable storage medium that stores software components of the multi-service analog telephone adapter. The multi-service analog telephone adapter disclosed herein further comprises multiple physical communication ports directly or indirectly used to establish a communication link between the multi-service analog telephone adapter and user devices, and between the multi-service analog telephone adapter and devices of service providers that provide multiple network and telephony services. The physical communication ports provide points of data exchange to allow the multi-service analog telephone adapter to physically communicate with the user devices and other devices by following protocols of data exchange, for example, the communications protocols. The physical communication ports establish a communication link to simultaneously access the network and telephony services implementing multiple communications protocols. As used herein, the term “communication link” refers to a physical and/or a logical link such as a wireless link used to interconnect devices physically and/or logically between two or more locations for the purpose of data transmission. The communications protocols comprise, for example, an extensible messaging and presence protocol (XMPP), a session initiation protocol (SIP), a media gateway control protocol (MGCP), a peer to peer (P2P) protocol, etc. One or more physical communication ports of the multi-service analog telephone adapter receive user inputs from one or more of multiple user devices, for example, an analog telephone, a POTS phone, an analog fax machine, etc., in a voice mode or a data mode. The user inputs comprise, for example, textual information, numeric information, alphanumeric information, bits information, etc. The physical communication ports of the multi-service analog telephone adapter disclosed herein comprise Ethernet ports, foreign exchange subscriber (FXS) ports, foreign exchange office (FXO) ports, wireless ports such as Bluetooth® chip sets, etc. The Ethernet ports connect the multi-service analog telephone adapter to a communication network, for example, an internet protocol (IP) network, a virtual private network, etc. The physical communication ports comprise, for example, an internet port, a local area network (LAN) port, a wide area network (WAN) port, etc., that allow the multi-service analog telephone adapter to connect to the internet, for example, via Ethernet, a LAN, a WAN, etc., and communicate with service provider equipment, for example, VoIP service provider equipment. The foreign exchange subscriber ports connect the multi-service analog telephone adapter to analog telephones, for example, POTS phones. The foreign exchange office ports provide access to the PSTN service. The wireless ports wirelessly connect the multi-service analog telephone adapter to a cellular service. The physical communication ports further comprise, for example, universal serial bus (USB) ports that allow the multi-service analog telephone adapter to connect to a Bluetooth® adaptor to pair with a cell phone or another user device.

The multi-service analog telephone adapter disclosed herein further comprises software components executable by at least one processor. As used herein, the term “software components” refers to components of the multi-service analog telephone adapter that execute different processes of the multi-service analog telephone adapter independently and communicate with each other via different interfaces. The software components comprise a control engine, at least one voice communication engine, a notification engine, and a device management client engine. The control engine, in communication with the physical communication ports, selectively routes and bridges a call to one or more network and telephony services based on the user inputs and predetermined criteria. The predetermined criteria comprise, for example, type of the call, configuration parameters of the multi-service analog telephone adapter, etc.

The voice communication engine, in communication with the physical communication ports, provides access to the voice communication service, for example, the VoIP service, the cellular service, etc., among the network and telephony services. The notification engine, in communication with the physical communication ports, generates and transmits a notification in one or more of multiple communication modes to one or more of multiple user devices, on receipt of a message by each of the user devices. The communication modes comprise, for example, a data mode, a text mode, a voice mode, an audio mode, a video mode, an audiovisual mode, a multimedia mode, etc., and any combination thereof. The user devices are electronic devices, for example, personal computers, laptops, tablet computing devices, mobile phones, personal digital assistants, etc.

The device management client engine, in communication with a device management server, provides remote access to the multi-service analog telephone adapter for configuring parameters associated with the multi-service analog telephone adapter and one or more user devices. The device management server enables remote management and monitoring of the multi-service analog telephone adapter and one or more of the user devices via the multi-service analog telephone adapter. In an embodiment, the device management server is implemented as a device management portal website in a cloud computing environment for allowing users to remotely manage and monitor the multi-service analog telephone adapters. As used herein, the term “cloud computing environment” refers to a processing environment comprising configurable computing physical and logical resources, for example, networks, servers, storage, applications, services, etc., and data distributed over a network, for example, the internet.

Disclosed herein is also a computer implemented method for bridging an analog telephone service to one or more of multiple network and services. The physical communication ports of the multi-service analog telephone adapter disclosed herein receive user inputs, for example, a dialed number associated with a call from one or more user devices in the voice mode or the data mode. The physical communication ports transmit the received user inputs to the control engine of the multi-service analog telephone adapter. The control engine selects one of the network and telephony services based on the received user inputs and the predetermined criteria. The voice communication engine of the multi-service analog telephone adapter periodically contacts a service provider associated with the selected network and telephony service for determining availability of the selected network and telephony service. In an embodiment, the voice communication engine authenticates the multi-service analog telephone adapter with a communication server of the contacted service provider. The control engine then selectively routes and bridges the call to the selected network and telephony service based on the availability. In an embodiment, the notification engine of the multi-service analog telephone adapter generates an error notification on unavailability of the selected network and telephony service.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented system for bridging an analog telephone service to one or more of multiple network and telephony services using a multi-service analog telephone adapter.

FIG. 2A exemplarily illustrates a block diagram showing hardware components of the multi-service analog telephone adapter.

FIG. 2B exemplarily illustrates a block diagram showing software components of the multi-service analog telephone adapter.

FIG. 3 illustrates a computer implemented method for bridging an analog telephone service to one or more of multiple network and telephony services using the multi-service analog telephone adapter.

### DETAILED DESCRIPTION OF THE INVENTION

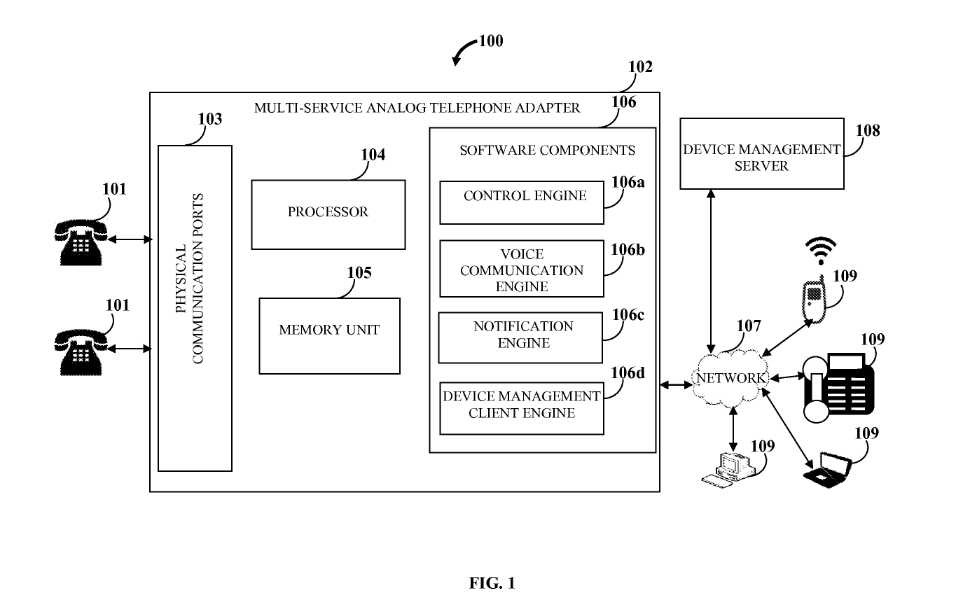

FIG. 1 illustrates a computer implemented system 100 for bridging an analog telephone service to one or more of multiple network and telephony services. The analog telephone service is a basic form of voice-grade telephone service, for example, a plain old telephone service (POTS). As used herein, the term “network and telephony services” refers to communication services such as voice and data services associated with data storage, voice and data transmission, voice and data reception, data manipulation, data presentation, etc., implemented using a client-server or a peer-to-peer architecture based on communication protocols. The network and telephony services comprise, for example, a cellular service, a public switched telephone network (PSTN) service, a voice over internet protocol (VoIP) service, a plain old telephone service (POTS), etc. Also, as used herein, the term “communications protocol”, also referred to as a “network protocol”, is a system of digital rules for exchanging messages within or between devices.

The computer implemented system 100 disclosed herein comprises a multi-service analog telephone adapter 102. The multi-service analog telephone adapter 102 comprises at least one processor 104 and a non-transitory computer readable storage medium, for example, a memory unit 105 communicatively coupled to the processor 104. The processor 104 comprises multiple processing cores, for example, an ARM processor, a microprocessor without interlocked pipeline stages (MIPS), an Itanium® architecture (IA) processor, a digital signal processor (DSP), etc. The multi-service analog telephone adapter 102 further comprises multiple physical communication ports 103 and software components 106 executable by the processor 104. As used herein, the term “physical communication ports” refers to connection resources directly or indirectly used to establish a communication link between the multi-service analog telephone adapter and user devices, and between the multi-service analog telephone adapter and devices of service providers that provide multiple network and telephony services. The physical communication ports provide points of data exchange to allow the multi-service analog telephone adapter 102 to physically communicate with the user devices and other devices by following protocols of data exchange, for example, the communication protocols.

Also, as used herein, the term “software components” refers to components of the multi-service analog telephone adapter 102 that execute different processes of the multi-service analog telephone adapter 102 independently and communicate with each other via different interfaces. The memory unit 105 is configured to store software components 106 of the multi-service analog telephone adapter 102.

The physical communication ports 103 establish a communication link to simultaneously access multiple network and telephony services implementing multiple communications protocols. As used herein, the term “communication link” refers to a physical and/or a logical link such as a wireless link used to interconnect devices physically and/or logically between two or more locations for the purpose of data transmission. The communications protocols are network protocols comprising, for example, an extensible messaging and presence protocol (XMPP), a session initiation protocol (SIP), a media gateway control protocol (MGCP), a peer to peer (P2P) protocol, etc. The physical communication ports 103 receive user inputs from one or more of multiple user devices, for example, an analog telephone, a POTS phone, an analog fax machine, a mobile phone, a smart phone, a tablet computing device, a personal digital assistant, etc., in a voice mode or a data mode. The user inputs comprise, for example, textual information, numeric information, alphanumeric information, bits information, etc. The physical communication ports 103 allow the multi-service analog telephone adapter 102 to access any installed network and telephony service. The multi-service analog telephone adapter 102 disclosed herein supports multiple signaling protocols, for example, multiple SIP services and multiple XMPP services simultaneously.

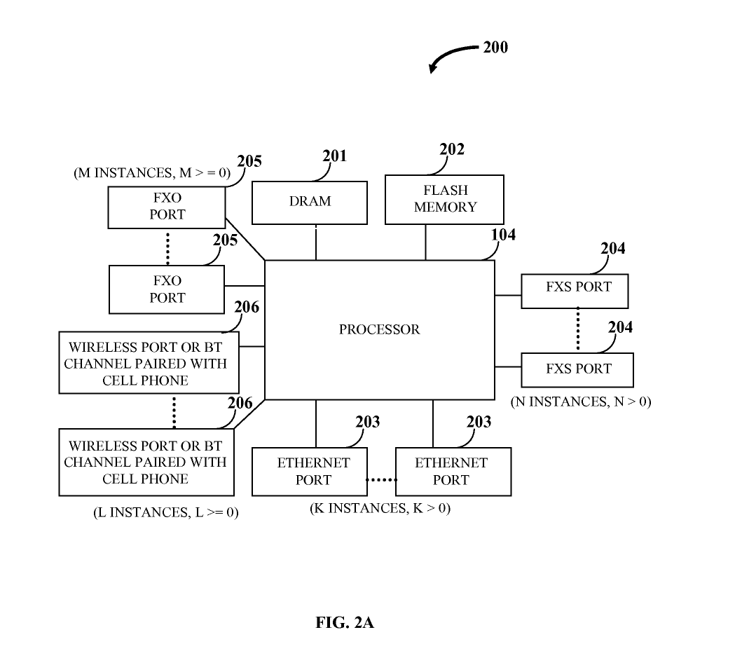

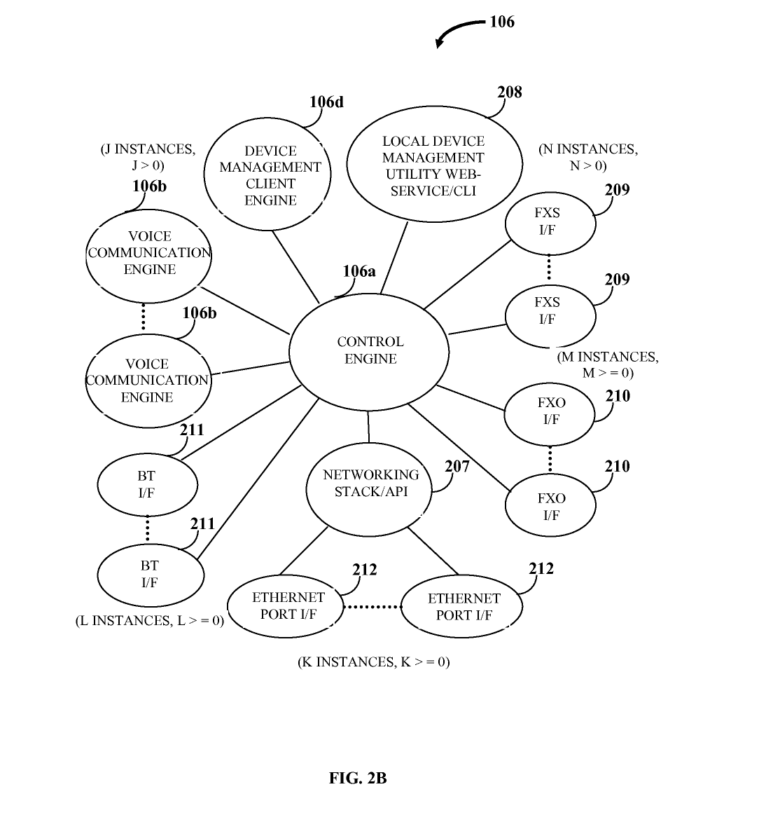

The physical communication ports 103 of the multi-service analog telephone adapter 102 disclosed herein comprise one or more Ethernet ports, one or more foreign exchange subscriber (FXS) ports, one or more foreign exchange office (FXO) ports, and one or more wireless ports such as Bluetooth® chip sets as exemplarily illustrated in FIG. 2A. The Ethernet ports connect the multi-service analog telephone adapter 102 to a communication network, for example, an internet protocol (IP) network, a virtual private network, etc. The physical communication ports 103 comprise, for example, an internet port, a local area network (LAN) port, a wide area network (WAN) port, etc., that allow the multi-service analog telephone adapter 102 to connect to the internet, for example, via Ethernet, a LAN, a WAN, etc., and communicate with service provider equipment, for example, VoIP service provider equipment. The foreign exchange subscriber (FXS) ports connect the multi-service analog telephone adapter 102 to analog telephones, for example, POTS phones. In an embodiment, the FXS ports are configured from a subscriber line interface card (SLIC) chip comprising multiple SLIC channels. Each SLIC channel implements each FXS port. The foreign exchange office (FXO) ports are physical communication ports where analog telephone lines are connected. The FXO ports provide access to a PSTN service among the network and telephony services. The FXO ports are configured from a direct access arrangement (DAA) chip comprising multiple DAA channels, where each DAA channel implements each FXO port. The wireless ports wirelessly connect the multi-service analog telephone adapter 102 to a cellular service. The wireless ports facilitate calls through cellular networks. The wireless ports provide a backup service for establishing emergency calls via the cellular network, when the telephone network or the network and telephony service connected to the multi-service analog telephone adapter 102 is out of service. The physical communication ports 103 further comprise, for example, universal serial bus (USB) ports that allow the multi-service analog telephone adapter 102 to connect, for example, to a Bluetooth® adaptor capable of pairing with a cell phone or another user device.

The hardware components of the multi-service analog telephone adapter 102 are configured and assembled using off-the-shelf chip sets and components, and are mass produced by certified contract manufacturers. The software components 106 of the multi-service analog telephone adapter 102 are developed using a combination of high level programming language, for example, C/C++ and assembly language, with a commercial or open source operating system to provide a framework. In an embodiment, the multi-service analog telephone adapter 102 disclosed herein is configured as a standalone multi-service analog telephone adapter 102 comprising permutations of one or more of the Ethernet ports, one or more of the FXS ports, a predefined number of the FXO ports, a predefined number of the wireless ports, for example, Bluetooth® channels, and one or more of the VoIP services to meet the minimum requirements of the multi-service analog telephone adapter 102. The predefined number of each of the physical communication ports 103 indicates zero or more.

The software components 106 of the multi-service analog telephone adapter 102 comprise a control engine 106a, at least one voice communication engine 106b, a notification engine 106c, and a device management client engine 106d. The control engine 106a, in communication with the physical communication ports 103, selectively routes and bridges a call to one or more network and telephony services based on the user inputs associated with the call and predetermined criteria. The predetermined criteria comprise, for example, a type of the call, configuration parameters of the multi-service analog telephone adapter 102, etc. The configuration parameters define call routing rules. Each call routing rule describes how a two way voice bridge is set up when a call is initiated on one of the physical communication ports via one or more network and telephony services. For example, when a user picks up a receiver of the user device, for example, an analog telephone device connected to an FXS port to dial a number, the control engine determines the network and telephony service that may be used to establish the call based on the dialed number as per the configuration parameters that are configured on the user device. The control engine 106a selectively routes a call to a network and telephony service based on the user input, for example, a name of a contact or an alphanumeric identifier pre-associated with a contact in the user's phone book or a contact list. When the user says the name of the contact or dials the alphanumeric identifier of the contact that the user wants to call, the control engine 106a processes the name or the alphanumeric identifier received to route the call to the network and telephony service mapped to the contact being called. The multi-service analog telephone adapter 102 performs mapping of the contacts and the network and telephony services as a part of the configuration process of the multi-service analog telephone adapter 102.

The control engine 106a selectively routes the call based on the type of the call, for example, a domestic call may be routed to a network and telephony service offering cheaper calling rates within the user's country or state or city. In another example, the control engine 106a routes an international call to a network and telephony service offering cheaper calling rates outside the user's country. In another example, the control engine 106a routes an emergency call to a network and telephony service that offers a reliable call quality and call connection speed within the user's area. The control engine 106a performs selective routing of a call based on the configuration parameters of the multi-service analog telephone adapter 102. The configuration parameters are set at the configuration stage of the multi-service analog telephone adapter 102. For example, the user selects a predefined number of network and telephony services and configures the selected network and telephony services on the multi-service analog telephone adapter 102.

The voice communication engine 106b, in communication with one or more physical communication ports 103, provides access to a voice communication service, for example, the VoIP service, the cellular service, etc., among the network and telephony services. The voice communication engine 106b provides access to network and telephony services, for example, VoIP services to enable the user devices 101, for example, the POTS phones or the analog telephones to establish calls with recipient devices 109 over a network 107, via the multi-service analog telephone adapter 102. The recipient devices 109 are electronic devices, for example, VoIP phones, personal computers, tablet computing devices, mobile computers, mobile phones, smart phones, portable computing devices, laptops, personal digital assistants, touch centric devices, workstations, client devices, portable electronic devices, network enabled computing devices, interactive network enabled communication devices, any other suitable computing equipment and combinations of multiple pieces of computing equipment, etc. The network 107 is, for example, a telephone network and/or a data network that connects exchanges, switches, etc., for example, a wired telephony network, a wireless network, a voice call network, a signaling system number 7 (SS7) network, an internet protocol data network, other data networks, etc. The voice communication engine 106b of the multi-service analog telephone adapter 102 periodically contacts a network and telephony service to verify if the network and telephony service is available in order to provide access to the voice communication services. In an embodiment, the voice communication engine 106b of the multi-service analog telephone adapter 102 periodically contacts each of the configured network and telephony services to verify if the network and telephony services are available.

The notification engine 106c, in communication with the physical communication ports 103, generates and transmits a notification in one or more of multiple communication modes to one or more user devices 101 on receipt of a message by each of the user devices 101. As used herein, the term “communication modes” refers to a medium used for transmission and reception of data being conveyed. The communication modes, for example, a data mode, a text mode, a voice mode, an audio mode, a video mode, an audiovisual mode, a multimedia mode, etc., and any combination thereof are used to send notifications to the user devices 101. Consider an example where an analog user device 101 such as the analog telephone or the POTS phone connected to the multi-service analog telephone adapter 102 receives a text message. The notification engine 106c of the multi-service analog telephone adapter 102 generates a notification of the received text message. The notification engine 106c then sends the generated notification to the user's electronic mail identity, for example, via electronic mail or to the user's cellular phone or the user's analog telephone via a pre-recorded voice message.

The device management client engine 106d of the multi-service analog telephone adapter 102, in communication with a device management server 108, provides remote access to the multi-service analog telephone adapter 102 for configuring parameters associated with the multi-service analog telephone adapter 102 and one or more user devices 101. The device management server 108 enables remote management and monitoring of the multi-service analog telephone adapter 102 and the user devices 101 via the multi-service analog telephone adapter 102. The device management client engine 106d remotely and periodically checks, downloads, and applies configuration updates and new software applications for the multi-service analog telephone adapter 102 from the device management server 108 via the network 107. In an embodiment, the device management client engine 106d checks, downloads, and applies the configuration updates and new software updates, when triggered by a message from the device management server 108. In an embodiment, the device management server 108 is implemented as a device management portal website in a cloud computing environment. As used herein, the term “cloud computing environment” refers to a processing environment comprising configurable computing physical and logical resources, for example, networks, servers, storage, applications, services, etc., and data distributed over a network, for example, the internet. The cloud computing environment provides on-demand network access to a shared pool of the configurable computing physical and logical resources. The multi-service analog telephone adapter 102 is accessible through multiple browsers via the device management client engine 106d, and the device management server 108 for example, Internet Explorer® (IE) 7, IE 8, and IE 9 of Microsoft Corporation, Mozilla® Firefox® of Mozilla Foundation, Safari® of Apple, Inc., Chrome of Google, Inc., etc., and is compatible with, for example, hypertext markup language 5 (HTML5), etc.

The device management portal website provides additional features with a graphical user interface and also provides textual explanations. The device management portal website overcomes firewall issues as the multi-service analog telephone adapter 102 periodically checks in or synchronizes with the device management server 108, thus punching a hole through the firewall. In an embodiment, the device management portal website is developed using standard web development tools, for example hypertext markup language (HTML), hypertext preprocessor (PHP), and JavaScript® of Oracle America, Inc., with a web server such as Apache on Linux®. In another embodiment, the multi-service analog telephone adapter 102 supports local device management with a built-in web server and a command line interface (CLI) utility.

The memory unit 105 of the multi-service analog telephone adapter 102 stores programs, applications, and data of the multi-service analog telephone adapter 102. For example, the memory unit 105 stores the software components 106 such as the control engine 106a, the voice communication engine 106b, the notification engine 106c, and the device management client engine 106d of the multi-service analog telephone adapter 102. The memory unit 105 is, for example, a random access memory (RAM) or another type of dynamic storage device that stores information and instructions for execution by the processor 104. The memory unit 105 also stores temporary variables and other intermediate information used during execution of the instructions by the processor 104. The memory unit 105 further comprises a dynamic random access memory (DRAM) 201 and a flash memory 202 exemplarily illustrated in FIG. 2A. In an embodiment, the computer implemented system 100 disclosed herein comprises another type of static storage device that stores static information and instructions for the processor 104.

In another embodiment, the multi-service analog telephone adapter 102 disclosed herein is configured by providing one or more variations in the multi-service analog telephone adapter 102. In one variation, one or more of the Ethernet ports are replaced with other networking technologies such as a fiber optic service FiOS® of Verizon Communications, Inc., or a multimedia over coax alliance MoCA® of Multimedia Over Coax Alliance, Inc. In another variation, one or more of the FXS ports are replaced with basic rate interface (BRI) ports that connect to integrated services digital network (ISDN) phones. In yet another variation, one or more of the FXO ports are replaced with the BRI ports that connect to the ISDN lines. In yet another variation, one or more of the wireless ports or the Bluetooth® (BT) channels are replaced with complete cellular access modules, for example, global system for mobile communication (GSM), code division multiple access (CDMA), etc., that can communicate directly to cellular networks for service, without needing an external cell phone as the bridge. In another embodiment, the multi-service analog telephone adapter 102 is configured with all the FXS ports, FXO ports, BRI ports, Ethernet ports, wireless ports or cellular modules integrated directly on the main board of the multi-service analog telephone adapter 102. In another embodiment, some or all of the physical communication ports 103 are configured as add-on dongles that connect to the multi-service analog telephone adapter 102 via a standard connection, for example, universal serial bus (USB) ports.

In another embodiment, the multi-service analog telephone adapter 102 disclosed herein is embedded into other communication systems. For example, an N-port multi-service analog telephone adapter 102 can be incorporated in a router product or a digital subscriber line (DSL) modem and a router combination product, or a triple play cable set-top box, or a gaming console such as XBox, play station (PS3), etc. As used herein, the term “N” in N-port multi-service analog telephone adapter 102 refers to a predefined number of ports required to meet the minimum standard requirements of the multi-service analog telephone adapter 102.

FIG. 2A exemplarily illustrates a block diagram showing hardware components 200 of the multi-service analog telephone adapter 102. The hardware components 200 comprise the processor 104 and multiple physical communication ports 103 exemplarily illustrated in FIG. 1, the dynamic random access memory (DRAM) 201, and the flash memory 202. The term “processor” refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 104 may also be implemented as a processor set comprising, for example, a general purpose microprocessor and a math or graphics co-processor. The processor 104 is selected, for example, from the Intel® processors such as the Itanium® microprocessor or the Pentium® processors, Advanced Micro Devices (AMD®) processors such as the Athlon® processor, UltraSPARC® processors, micro SPARC® processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, etc.

The processor 104 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., Palm OS®, the Solaris operating system developed by Sun Microsystems, Inc., the Android operating system, Windows Phone™ operating system of Microsoft Corporation, BlackBerry® operating system of Research in Motion Limited, the iOS operating system of Apple Inc., the Symbian® operating system of Symbian Foundation Limited, etc. The computer implemented system 100 employs the operating system for performing multiple tasks. The operating system is responsible for management and coordination of activities and sharing of resources of the computer implemented system 100. The operating system further manages security of the computer implemented system 100, peripheral devices connected to the computer implemented system 100, and network connections. The operating system employed on the computer implemented system 100 recognizes, for example, inputs provided by the user via one of the physical communication ports 103, files, and directories stored locally on the memory unit 105, for example, a hard drive. The operating system on the computer implemented system 100 executes different programs using the processor 104.

The scope of the multi-service analog telephone adapter 102 disclosed in the detailed description of FIG. 1 is not limited to the multi-service analog telephone adapter 102 employing a processor 104. The multi-service analog telephone adapter 102 may also employ a controller or a microcontroller. Any processor 104 with sufficient horse power and enough pins to interface to needed external chip sets or peripherals and any DRAM 201 module or any flash memory 202 that the processor 104 supports may be used in the multi-service analog telephone adapter 102. The size of the DRAM 201 is configured to support the intended functions of the multi-service analog telephone adapter 102. The size of the flash memory 202 is configured to store the software and configuration data. Computer applications and programs are used for operating the multi-service analog telephone adapter 102. The programs and the configuration parameters are stored in the flash memory 202 and loaded into the DRAM 201 of the multi-service analog telephone adapter 102 during execution. In an embodiment, the computer applications and programs may be loaded into the DRAM directly via the network. The processor 104 and the DRAM 201 execute the software components 106 of the multi-service analog telephone adapter 102 exemplarily illustrated in FIG. 1 and FIG. 2B. The flash memory 202 stores a compiled software code and configuration data for the physical communication ports 103 and the software components 106.

The physical communication ports 103 comprise the Ethernet ports 203, the foreign exchange subscriber (FXS) ports 204, the foreign exchange office (FXO) ports 205, and wireless ports 206 such as Bluetooth® ports as disclosed in the detailed description of FIG. 1. One or more instances of Ethernet ports 203 connect to an internet protocol (IP) network. Each instance of the foreign exchange subscriber ports 204 connects to a plain old telephone service (POTS) phone. Each FXS port has a set of configuration parameters comprising a set of outbound call routing rules to control the selection of the network and telephony service to be used for establishing calls based on a number dialed by the user. One of the FXS ports is assigned to the user for establishing the call. The foreign exchange office (FXO) ports provide access to the PSTN service. Each instance of the foreign exchange office ports 205 connects to a public switched telephone network (PSTN) line also referred to as a landline to provide access to a PSTN service. Each instance of the wireless ports 206 is paired with a cell phone that connects wirelessly to a cellular phone service. The Ethernet ports 203 can be implemented as part of the SoC chip that houses the processor 104. In an embodiment, some or all of the Ethernet ports 203 are replaced with other networking technologies such as FiOS® or MoCA®. In another embodiment, some or all of the FXS ports 204 are replaced with basic rate interface (BRI) ports that connect to integrated services digital network (ISDN) phones. In another embodiment, some or all of the FXO ports 205 are replaced with BRI ports that connect to ISDN lines. Any compliant wireless port 206 may be used in the multi-service analog telephone adapter 102.

FIG. 2B exemplarily illustrates a block diagram showing the software components 106 of the multi-service analog telephone adapter 102. The software components 106 comprise the control engine 106a, the communication service engine, and the device management client engine 106d as disclosed in the detailed description of FIG. 1. The control engine 106a coordinates the resources on the multi-service analog telephone adapter 102 and controls call routing and call bridging among different network and telephony services. Each instance of the voice communication engine 106b provides and controls access to any external voice communication service, for example, the voice over internet protocol (VoIP) service implementing multiple communications protocols such as the session initiation protocol (SIP) or the extensible messaging and presence protocol (XMPP) as signaling protocols. The software components 106 further comprise a foreign exchange subscriber (FXS) interface 209, a foreign exchange office (FXO) interface 210, a wireless interface or a Bluetooth® interface 211, a networking stack 207, an Ethernet port interface 212, and a local device management utility web service 208.

Each instance of the foreign exchange subscriber interface 209 is a software interface to the on-board FXS port 204. Each instance of the foreign exchange office interface 210 is a software interface to the on-board FXO port 205. Each instance of the wireless interface or the Bluetooth® interface 211 is a software interface to the on-board wireless port 206 paired with a cell phone. The networking stack 207 is an application programming interface (API) or an abstraction layer configured to access the internet protocol (IP) network. Each instance of the Ethernet port interface 212 is a software interface to the Ethernet port 203. The device management client engine 106d is, for example, a state machine that supports remote device management via the device management server 108 as disclosed in the detailed description of FIG. 1. The local device management utility web service 208 or a command line interface (CLI) utility supports local device management with a built in web server and/or CLI.

The processor 104, exemplarily illustrated in FIG. 1 and FIG. 2A, retrieves instructions for executing the software components 106, for example, the control engine 106a, the voice communication engine 106b, the notification engine 106c, and the device management client engine 106d, of the multi-service analog telephone adapter 102 from the memory unit 105. The instructions fetched by the processor 104 from the memory unit 105 after being processed are decoded. The instructions are stored in an instruction register in the processor 104. After processing and decoding, the processor 104 executes the instructions. For example, the control engine 106a of the multi-service analog telephone adapter 102 defines instructions for selectively routing and bridging a call to the network and telephony services based on predetermined criteria. The voice communication engine 106b of the multi-service analog telephone adapter 102 defines instructions for providing access to a voice communication service among the network and telephony services. The voice communication engine 106b defines instructions for providing access to external VoIP services to enable the analog telephones 101a such as the POTS phones to establish calls with VoIP phones 109b over the network 107, via the multi-service analog telephone adapter 102.

In an embodiment, the voice communication engine 106b defines instructions for periodically contacting the network and telephony services to verify their availability for providing access to voice communication services at the time of establishing a call. The notification engine 106c defines instructions for generating and transmitting the notification in one or more of multiple communication modes to one or more of multiple user devices 101, on receipt of a message by each of the user devices 101. The device management client engine 106d of the multi-service analog telephone adapter 102 defines instructions for providing remote access to the multi-service analog telephone adapter 102 for configuring parameters associated with the user devices 101.

The processor 104 of the multi-service analog telephone adapter 102 retrieves the instructions defined by the control engine 106a, the voice communication engine 106b, the notification engine 106c, and the device management client engine 106d, and executes the instructions, thereby performing one or more processes defined by those instructions. At the time of execution, the instructions stored in an instruction register are examined to determine the operations to be performed. The processor 104 then performs the specified operations. The operations comprise arithmetic operations and logic operations. The operating system performs multiple routines for performing a number of tasks required to assign memory for execution of the software components 106, for example, the control engine 106a, the voice communication engine 106b, the notification engine 106c, and the device management client engine 106d of the multi-service analog telephone adapter 102. The tasks performed by the operating system comprise, for example, assigning memory to the software components 106 of the multi-service analog telephone adapter 102 and data used by the multi-service analog telephone adapter 102, moving data between the memory unit 105 and disk units, and handling input/output operations. The operating system performs the tasks on request by the operations and after performing the tasks, the operating system transfers the execution control back to the processor 104. The processor 104 continues the execution.

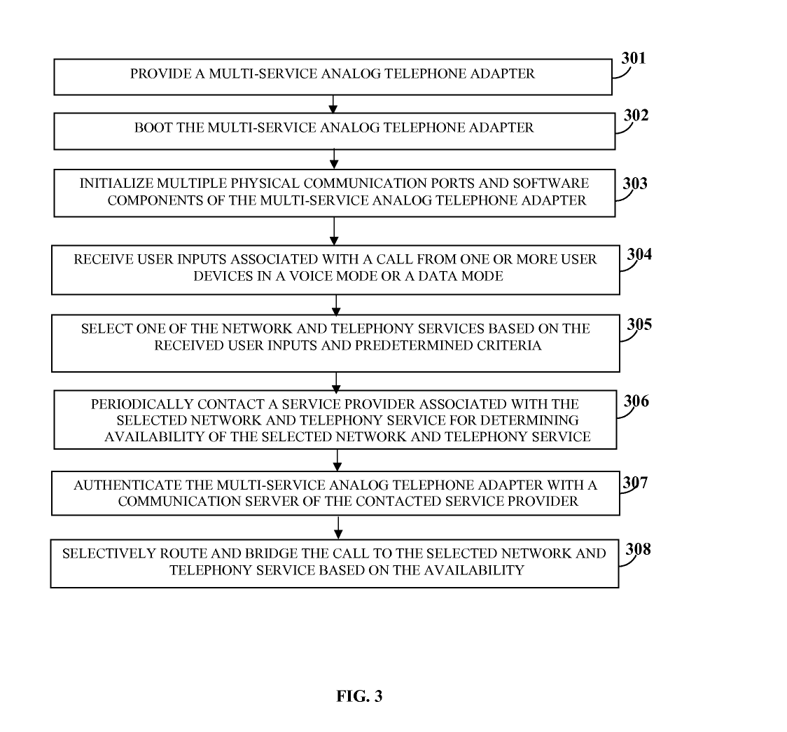

FIG. 3 illustrates a computer implemented method for bridging an analog telephone service to one or more of multiple network and telephony services using the multi-service analog telephone adapter 102 exemplarily illustrated in FIG. 1. The network and telephony services comprise the cellular service, the public switched telephone network (PSTN) service, the voice over internet protocol service (VoIP), and the plain old telephone service (POTS) as disclosed in the detailed description of FIG. 1. The computer implemented method disclosed herein provides 301 the multi-service analog telephone adapter 102 comprising the software components 106, that is, the control engine 106a, at least one voice communication engine 106b, the notification engine 106c, and the device management client engine 106d, and multiple physical communication ports 103 for establishing a communication link to simultaneously access the network and telephony services implementing multiple communications protocols, for example, a session initiation protocol, an extensible messaging and presence protocol, a media gateway control protocol, a peer to peer protocol, etc.

The computer implemented method disclosed herein boots 302 the multi-service analog telephone adapter 102 by loading software from the flash memory to the dynamic random access memory (DRAM) 201 exemplarily illustrated in FIG. 2A. The processor begins execution by loading configuration parameters from the flash memory 202 and initializing 303 the physical communication ports 103 and the software components 106 of the multi-service analog telephone adapter 102 according to the configuration parameters. In an embodiment, the software may be loaded into the DRAM 201 directly via the network 107.

The physical communication ports 103 of the multi-service analog telephone adapter 102 receive 304 user inputs associated with a call from one or more user devices 101 in a voice mode or a data mode. The user inputs are, for example, a voice input, a data input such as an alphanumeric identifier mapped to a contact in the phone book, etc. The physical communication ports 103 receive 304 the user inputs from the user devices connected to the multi-service analog telephone adapter 102, for example, the analog telephone or the analog fax machine. To make the outgoing call, the user picks up the analog phone connected to the assigned physical communication port and provides the user inputs. The control engine 106a processes the received user inputs for routing the call. The control engine 106a selects 305 a network and telephony service based on the received user inputs and predetermined criteria comprising, for example, a type of the call, the configuration parameters of the multi-service analog telephone adapter 102, etc. The multi-service analog telephone adapter 102 allows the user to define and store outgoing call routing rules as predefined criteria for routing a call. For example, the user can define rules for routing all international calls through one network and telephony service, all domestic calls through another network and telephony service, and emergency calls through the public switched telephone network (PSTN) service or the cellular service whichever is available. If the XMPP service is configured on the multi-service analog telephone adapter 102, the user can pick up the analog telephone connected to the multi-service analog telephone adapter 102 to establish calls to his/her contacts or receive calls from his/her contacts using the XMPP service in a manner similar to making calls using a traditional home phone service. When the user dials a number he/she wants to call, the control engine 106a selects the appropriate network and telephony service to connect the call according to the predefined rules and the number dialed. For example, 911 can be routed to a PSTN service on an FXO port, a US telephone number can be routed to use a free XMPP service, etc.

The voice communication engine 106b periodically, for example, every sixty seconds, contacts 306 a service provider associated with the selected network and telephony service for determining availability of the selected network and telephony service. The periodical contact is attempted in the background irrespective of the call being made for maintaining a connection with the service provider associated with the selected network and telephony service. The maintenance of contact helps the service provider of the selected network and telephony service to know that the multi-service analog telephone adapter 102 is still online. Thus, the service provider may send incoming calls to the multi-service analog telephone adapter 102 when a caller calls the user device's 101 phone number. The voice communication engine 106b authenticates 307 the multi-service analog telephone adapter 102 with a communication server (not shown) of the contacted service provider. The authentication process involves a login process. The voice communication engine 106b provides a user identifier and a password associated with each of the contacted service providers to authenticate the multi-service analog telephone adapter 102 with the communication server of the contacted service provider. Once login is successful, the voice communication engine 106b is ready to make and receive calls on the network and telephony service that has authenticated the multi-service analog telephone adapter 102. The voice communication engine 106b is configured to exchange signaling messages using the communications protocols such as the session initiation protocol (SIP) or the extensible messaging and presence protocol (XMPP) with the service provider that has authenticated the multi-service analog telephone adapter 102. The control engine 106a selectively routes and bridges 308 the call to the selected network and telephony service based on the availability. In an embodiment, the control engine 106a may assign a priority to each of the available network and telephony services based on parameters such as calling rates, network coverage, etc., and route the call using these available network and telephony services priority wise.

Incoming calls on a network and telephony service can ring one or more FXS ports 204 of the multi-service analog telephone adapter 102. Each network and telephony service has a set of incoming call routing rules configured to determine the appropriate FXS ports 204 that are to be used and to control the ringing of the appropriate FXS ports 204. The incoming call routing rules are defined based on the caller's number. Instead of ringing the analog phone connected to the multi-service analog telephone adapter 102, the incoming call routing rules can also be configured to route the call to a number on any other network and telephony service, thus setting up a bridge between two network and telephony services. The FXS interface supports voice matching for letting the user dial by saying the name of the called person from a phone book. In an embodiment, the phone book may be loaded using a standard loading procedure. The user can invoke voice dialing by entering an access code, for example, *0#. The access code is not required when the voice input mode is set as the default mode. On activating the voice mode of input, the FXS interface responds with a short tone or announcement. After the FXS interface captures the user's voice, the FXS interface transmits the voice input to the control engine 106a. The control engine 106a applies a matching algorithm to find matching entries in the phone book and transmits the results to the FXS interface. The FXS interface displays the matches found, if any, from the phone book and requests the user to select the correct contact from the same. The user can select one of the matches by saying or pressing a digit corresponding to the correct contact.

The notification engine 106c generates and transmits a notification in one or more of multiple communication modes to one or more of multiple user devices 101 connected to the multi-service analog telephone adapter 102, on receipt of a message by each of the user devices. For example, when a text message is received on a network and telephony service, the multi-service analog telephone adapter 102 notifies the user of the incoming text message in a manner similar to alerting the user on incoming voice calls. The text message is routed to one or more FXS ports 204. The FXS interface notifies the user by generating and transmitting a special ring and caller-identifier that indicates that a new text message is received. The FXS interface also displays the first few words of the text message received. The user, after being notified, may then go online to read the full text message. The notification engine 106c also generates an error notification on unavailability of the selected network and telephony services. The device management client engine 106d provides remote access to the multi-service analog telephone adapter 102 for configuring parameters associated with the multi-service analog telephone adapter 102 and the analog user devices.

Consider an example where a user wants to establish a call via the multi-service analog telephone adapter 102. The user connects the multi-service analog telephone adapter 102 to an electrical power outlet to power up the multi-service analog telephone adapter 102. The user then connects one of the Ethernet ports 203 on the multi-service analog telephone adapter 102 to an IP network that can reach out to the internet. The user also connects a POTS phone to one of the phone ports on the multi-service analog telephone adapter 102. If the user wants to use the PSTN service, then the user has to connect a live PSTN line to one of the FXO ports 205 on the multi-service analog telephone adapter 102. For using the cellular service, the user pairs and connects an external cell phone with one of the wireless ports 206 on the multi-service analog telephone adapter 102.

To make the outgoing call, the user picks up the analog phone connected to the assigned physical communication port and dials the number. When the FXS interface receives a complete number from the FXS port 204, the FXS interface passes the number to the control engine 106a to request a call made to that number. The control engine 106a compares the number against the call routing rules for the requesting FXS interface to select a network and telephony service to fulfill the request. If the selected network and telephony service is available, then the control engine 106a accepts the request and proceeds with establishing the call on the selected network and telephony service. If the selected network and telephony service is unavailable, then the control engine 106a rejects the request and the FXS interface alerts the user with an error indication tone, for example, a fast busy tone.

It will be readily apparent that the various methods, algorithms, and computer programs disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media comprising a dynamic random access memory (DRAM) that typically constitutes a main memory. Volatile media comprise, for example, a register memory, a processor cache, a random access memory (RAM), etc. Transmission media comprise, for example, coaxial cables, copper wire, fiber optic cables, modems, etc., comprising wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Other object-oriented, functional, scripting, and/or logical programming languages may also be used. The computer program codes or software programs may be stored on or in one or more mediums as object code. Various aspects of the computer implemented method and system disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and system disclosed herein may be implemented as programmed elements, or non-programmed elements, or any suitable combination thereof. The computer program product disclosed herein comprises computer executable instructions embodied in a non-transitory computer readable storage medium, wherein the computer program product comprises one or more computer program codes for implementing the processes of various embodiments.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices may comprise processors, for example, the Intel® processors, Advanced Micro Devices (AMD®) processors, UltraSPARC® processors, hp® processors, International Business Machines (IBM®) processors, RISC based computer processors of ARM Holdings, Motorola® processors, etc., that are adapted to communicate with the computers. In an embodiment, each of the computers is equipped with a network communication device, for example, a network interface card, a modem, or other network connection device suitable for connecting to a network. Each of the computers and the devices executes an operating system, for example, the Linux® operating system, the Unix® operating system, any version of the Microsoft® Windows® operating system, the Mac OS of Apple Inc., the IBM® OS/2, the Android® OS, the Blackberry® OS, the Solaris operating system developed by Sun Microsystems, Inc., or any other operating system. Handheld devices execute operating systems, for example, the Android operating system, the Windows Phone™ operating system of Microsoft Corporation, the BlackBerry® operating system of Research in Motion Limited, the iOS operating system of Apple Inc., the Symbian® operating system of Symbian Foundation Limited, etc. While the operating system may differ depending on the type of computer, the operating system will continue to provide the appropriate communications protocols to establish communication links with the network. Any number and type of machines may be in communication with the computers.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A multi-service analog telephone adapter comprising:
at least one processor;
a non-transitory computer readable storage medium communicatively coupled to said at least one processor, said non-transitory computer readable storage medium configured to store software components of said multi-service analog telephone adapter;
a plurality of physical communication ports configured to establish a communication link to simultaneously access a plurality of network and telephony services implementing a plurality of communications protocols, wherein one or more of said physical communication ports are configured to receive user inputs from one or more of a plurality of user devices in one of a voice mode and a data mode; and
said software components executable by said at least one processor, wherein said software components comprise:
a control engine, in communication with said physical communication ports, configured to selectively route and bridge a call to one or more of said network and telephony services based on said user inputs associated with said call and predetermined criteria;
at least one voice communication engine, in communication with said one or more of said physical communication ports, configured to provide access to a voice communication service among said network and telephony services;
a notification engine, in communication with said one or more of said physical communication ports, configured to generate and transmit a notification in one or more of a plurality of communication modes to said one or more of said user devices, on receipt of a message by each of said one or more of said user devices; and
a device management client engine, in communication with a device management server, configured to provide remote access to said multi-service analog telephone adapter for configuring parameters associated with said multi-service analog telephone adapter and one or more of said user devices.

2. The multi-service analog telephone adapter of claim 1, wherein said physical communication ports comprise:
Ethernet ports configured to connect said multi-service analog telephone adapter to a communication network;
foreign exchange subscriber ports configured to connect said multi-service analog telephone adapter to analog telephones;
foreign exchange office ports configured to provide access to a public switched telephone network service among said network and telephony services; and
wireless ports configured to wirelessly connect said multi-service analog telephone adapter to a cellular service among said network and telephony services.

3. The multi-service analog telephone adapter of claim 1, wherein said predetermined criteria comprise type of said call and configuration parameters of said multi-service analog telephone adapter.

4. The multi-service analog telephone adapter of claim 1, wherein said network and telephony services comprise a cellular service, a public switched telephone network service, a voice over internet protocol service, and a plain old telephone service.

5. The multi-service analog telephone adapter of claim 1, wherein said communications protocols comprise a session initiation protocol, an extensible messaging and presence protocol, a media gateway control protocol, and a peer to peer protocol.

6. The multi-service analog telephone adapter of claim 1, wherein said communication modes of said notification comprise a data mode, a text mode, a voice mode, an audio mode, a video mode, an audiovisual mode, a multimedia mode, and any combination thereof.

7. A computer implemented system for bridging an analog telephone service to one or more of a plurality of network and telephony services, comprising:
a multi-service analog telephone adapter comprising:
at least one processor;
a non-transitory computer readable storage medium communicatively coupled to said at least one processor, said non-transitory computer readable storage medium configured to store software components of said multi-service analog telephone adapter;
a plurality of physical communication ports configured to establish a communication link to simultaneously access said network and telephony services implementing a plurality of communications protocols, wherein one or more of said physical communication ports are configured to receive user inputs from one or more of a plurality of user devices in one of a voice mode and a data mode; and
said software components executable by said at least one processor, wherein said software components comprise:
a control engine, in communication with said physical communication ports, configured to selectively route and bridge a call to said one or more of said network and telephony services based on said user inputs associated with said call and predetermined criteria;
at least one voice communication engine, in communication with said one or more of said physical communication ports, configured to provide access to a voice communication service among said network and telephony services;
a notification engine, in communication with said one or more of said physical communication ports, configured to generate and transmit a notification in one or more of a plurality of communication modes to said one or more of said user devices, on receipt of a message by each of said one or more of said user devices; and
a device management client engine, in communication with a device management server, configured to provide remote access to said multi-service analog telephone adapter for configuring parameters associated with said multi-service analog telephone adapter and one or more of said user devices; and
said device management server, in communication with said device management client engine of said multi-service analog telephone adapter, said device management server configured to enable remote management and monitoring of said multi-service analog telephone adapter and one or more of said user devices via said multi-service analog telephone adapter.

8. The computer implemented system of claim 7, wherein said physical communication ports comprise:
Ethernet ports configured to connect said multi-service analog telephone adapter to a communication network;
foreign exchange subscriber ports configured to connect said multi-service analog telephone adapter to analog telephones;
foreign exchange office ports configured to provide access to a public switched telephone network service among said network and telephony services; and
wireless ports configured to wirelessly connect said multi-service analog telephone adapter to a cellular service among said network and telephony services.

9. The computer implemented system of claim 7, wherein said predetermined criteria comprise type of said call, and configuration parameters of said multi-service analog telephone adapter.

10. The computer implemented system of claim 7, wherein said network and telephony services comprise a cellular service, a public switched telephone network service, a voice over internet protocol service, and a plain old telephone service.

11. The computer implemented system of claim 7, wherein said communications protocols comprise a session initiation protocol, an extensible messaging and presence protocol, a media gateway control protocol, and a peer to peer protocol.

12. The computer implemented system of claim 7, wherein said communication modes of said notification comprise a data mode, a text mode, a voice mode, an audio mode, a video mode, an audiovisual mode, a multimedia mode, and any combination thereof.

13. A computer implemented method for bridging an analog telephone service to one or more of a plurality of network and telephony services, comprising:
providing a multi-service analog telephone adapter comprising:
at least one processor;
a non-transitory computer readable storage medium communicatively coupled to said at least one processor, said non-transitory computer readable storage medium configured to store software components of said multi-service analog telephone adapter;
a plurality of physical communication ports configured to establish a communication link to simultaneously access said network and telephony services implementing a plurality of communications protocols, said communications protocols comprising an extensible messaging and presence protocol; and
said software components executable by said at least one processor, wherein said software components comprise a control engine and at least one voice communication engine configured to communicate with said physical communication ports, wherein said at least one voice communication engine is configured to provide access to a voice communication service among said network and telephony services;
receiving user inputs associated with a call from one or more of a plurality of user devices in one of a voice mode and a data mode by one or more of said physical communication ports of said multi-service analog telephone adapter;
selecting one of said network and telephony services by said control engine of said multi-service analog telephone adapter based on said received user inputs and predetermined criteria;
periodically contacting a service provider associated with said selected one of said network and telephony services by said at least one voice communication engine of said multi-service analog telephone adapter for determining availability of said selected one of said network and telephony services; and
selectively routing and bridging said call to said selected one of said network and telephony services by said control engine based on said availability.

14. The computer implemented method of claim 13, further comprising generating and transmitting a notification in one or more of a plurality of communication modes to said one or more of said user devices by a notification engine of said multi-service analog telephone adapter, on receipt of a message by each of said one or more of said user devices, and wherein said communication modes comprise a data mode, a text mode, a voice mode, an audio mode, a video mode, an audiovisual mode, a multimedia mode, and any combination thereof.

15. The computer implemented method of claim 13, further comprising providing a device management client engine in said multi-service analog telephone adapter, in communication with a device management server, wherein said device management client engine is configured to provide remote access to said multi-service analog telephone adapter for configuring parameters associated with said multi-service analog telephone adapter and said one or more of said user devices.

16. The computer implemented method of claim 13, further comprising authenticating said multi-service analog telephone adapter with a communication server of said contacted service provider by said at least one voice communication engine of said multi-service analog telephone adapter.

17. The computer implemented method of claim 13, further comprising generating an error notification on unavailability of said selected one of said network and telephony services by a notification engine of said multi-service analog telephone adapter.

18. The computer implemented method of claim 13, wherein said physical communication ports comprise:
Ethernet ports configured to connect said multi-service analog telephone adapter to a communication network;
foreign exchange subscriber ports configured to connect said multi-service analog telephone adapter to analog telephones;
foreign exchange office ports configured to provide access to a public switched telephone network service among said network and telephony services; and
wireless ports configured to wirelessly connect said multi-service analog telephone adapter to a cellular service among said network and telephony services.

19. The computer implemented method of claim 13, wherein said predetermined criteria comprise said type of said call and configuration parameters of said multi-service analog telephone adapter.

20. The computer implemented method of claim 13, wherein said network and telephony services comprise a cellular service, a public switched telephone network service, a voice over internet protocol service, and a plain old telephone.
